(19) United States
(12) Patent Application Publication
(10) Pub. No.: US 2024/0029945 A1
(43) Pub. Date: Jan. 25, 2024

(54) COIL COMPONENT

(71) Applicant: SAMSUNG ELECTRO-MECHANICS CO., LTD., Suwon-si (KR)

(72) Inventors: Ju Hwan Yang, Suwon-si (KR); Jae Hun Kim, Suwon-si (KR); Doo Ho Park, Suwon-si (KR); Hye Hun Park, Suwon-si (KR); In Young Kang, Suwon-si (KR); Ki Young Yoo, Suwon-si (KR); Boum Seock Kim, Suwon-si (KR)

(73) Assignee: SAMSUNG ELECTRO-MECHANICS CO., LTD., Suwon-si (KR)

(21) Appl. No.: 18/093,961

(22) Filed: Jan. 6, 2023

(30) Foreign Application Priority Data
Jul. 25, 2022 (KR) 10-2022-0091925

(51) Int. Cl. H01F 27/32; H01F 17/00; C09D 125/18; C09D 133/08; C09D 133/10

(52) U.S. Cl. CPC H01F 27/324; H01F 17/0013; C09D 125/18; C09D 133/08; C09D 133/10; H01F 2017/002

(57) ABSTRACT

A coil component includes: a body; a coil disposed within the body; and an insulating film covering at least a portion of the coil in the body, wherein the insulating film includes a copolymer including a repeating unit derived from a monomer containing an unsaturated bond and a repeating unit derived from a parylene monomer.

### CROSS-REFERENCE TO RELATED APPLICATION

This application claims benefit of priority to Korean Patent Application No. 10-2022-0091925 filed on Jul. 25, 2022 in the Korean Intellectual Property Office, the disclosure of which is incorporated herein by reference in its entirety.

### TECHNICAL FIELD

The present disclosure relates to a coil component.

### BACKGROUND

Along with miniaturization and thinning of electronic

devices such as digital TVs, mobile phones, and notebook computers, there has been demand for miniaturization and high capacity of coil components applied to such electronic devices. Accordingly, while seeking a direction to lower a cost of magnetic materials, most commonly used power inductors are shifting from stacked type inductors to thin film type and winding type inductors.

Meanwhile, in the case of a thin-film power inductor, it is necessary to prevent contact between a conductor pattern constituting a coil and a magnetic material constituting a body, and to this end, it has been proposed to form an insulating film on a surface of the conductor pattern.

### SUMMARY

An aspect of the present disclosure is to provide a coil component having an improved coil withstand voltage.

Another aspect of the present disclosure is to provide a coil component having improved burring on an exposed surface of an external terminal.

Another aspect of the present disclosure is to provide a coil component capable of improving direct current resistance (Rdc) characteristics and dispersion.

Another aspect of the present disclosure is to provide a coil component capable of matching a coefficient of thermal expansion (CTE) between a coil and a magnetic body in the body.

One of several solutions proposed through the present disclosure is to form an insulating film on a surface of a coil using an organic thin film material including a copolymer of a monomer containing an unsaturated bond and a parylene monomer.

According to an aspect of the present disclosure, a coil component includes: a body; a coil disposed within the body; and an insulating film covering at least a portion of the coil in the body, wherein the insulating film may include a copolymer including a repeating unit derived from a monomer containing an unsaturated bond and a repeating unit derived from a parylene monomer.

According to an aspect of the present disclosure, a

coil component includes: a body; a coil disposed within the body; and an insulating film covering at least a portion of the coil in the body, wherein the insulating film incudes a copolymer including a structure represented by the following [Formula 1], where R¹ is a C₂-C₆ saturated hydrocarbon chain, R² and R³ are each independently a hydrogen or a C₁-C-₁₀ alkyl group, a and h are each independently an integer of 2 to 2500.

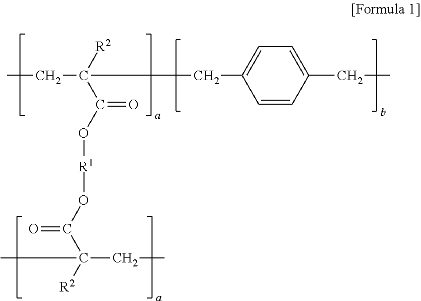

According to an aspect of the present disclosure, a coil component includes: a body; a coil disposed within the body; and an insulating film covering at least a portion of the coil in the body, wherein the insulating film may include a copolymer including a repeating unit derived from a monomer containing an unsaturated bond and at least two ether groups, and a repeating unit derived from a parylene monomer.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates an example of a coil component applied to an electronic device.

FIG. 2 is a schematic perspective view illustrating an example of a coil component.

FIG. 3 schematically illustrates an example of a cross-section I-I′ of the coil component of FIG. 2.

FIG. 4 schematically illustrates an example of cross-section II-II′ of the coil component of FIG. 2.

FIG. 5 schematically illustrates an example of one side surface of the body to which the first lead-out portion of the coil component of FIG. 2 is exposed.

FIG. 6 schematically illustrates an example of the other side surface of the body to which the second lead-out portion of the coil component of FIG. 2 is exposed.

FIG. 7 is a schematic perspective view illustrating another example of a coil component.

FIG. 8 schematically illustrates an example of a cross-section III-III′ of the coil component of FIG. 7.

FIG. 9 schematically illustrates an example of a lower surface of the body to which the first and second lead-out portions of the coil component of FIG. 7 are exposed.

FIGS. 10 to 12 schematically illustrate various examples of a cross-section for measuring a thickness of the insulating film of the coil component according to an embodiment.

FIGS. 13 and 14 schematically illustrate a cross-section for checking whether the insulating film on the lead-out portion of the coil component according to Example and Comparative Example is damaged, respectively.

FIG. 15 schematically illustrates a direct current resistance (Rdc) and distribution of a coil component according to Examples and Comparative Examples.

FIGS. 16 and 17 schematically illustrate a result of analyzing a material of the insulating film of the coil component according to Examples and Comparative Examples, respectively, by an FT-IR spectrum.

FIG. 18 schematically illustrates a result of as a material of an insulating film of a coil component according to an embodiment by an ¹H-NMR spectrum.

FIG. 19 schematically illustrates a result of analyzing a material of an insulating film of a coil component according to an embodiment by a ¹³C-NMR spectrum.

### DETAILED DESCRIPTION

Hereinafter, embodiments of the present disclosure will be described in detail with reference to the accompanying drawings. The present disclosure may, however, be exemplified in many different forms and should not be construed as being limited to the specific embodiments set forth herein, but should be understood to include various modifications, equivalents, and/or alternatives to the embodiments of the present disclosure. In relation to the description of the drawings, similar reference numerals may be used for similar components. In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may include other components as well, rather than excluding other components, unless specifically stated otherwise.

### Electronic Device

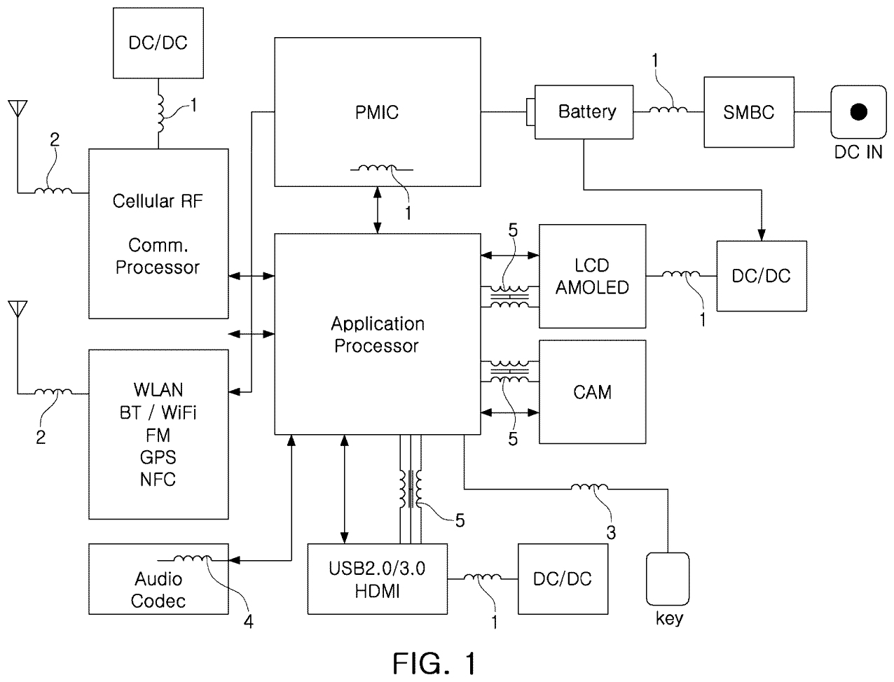

FIG. 1 schematically illustrates an example of a coil component applied to an electronic device. Referring to FIG. 1, it can be seen that various types of electronic components are used in electronic device. For example, focusing on an

Application Processor, DC/DC, Comm. Processor, WLAN BT WiFi FM GPS NFC, PMIC, Battery, SMBC, LCD AMOLED, Audio Codec, USB 2.0/3.0 HDMI, CAM, and the like may be used. In this case, various types of coil components may be appropriately applied according to the use thereof for the purpose of noise removal, and the like, between these electronic components. For example, there may be a power inductor 1, a high-frequency (HF) inductor 2, a general bead 3, a high-frequency bead (GHz Bead) 4, a common mode filter 5, and the like.

Specifically, the power inductor 1 may be used for stabilizing power by storing electricity in the form of a magnetic field to maintain an output voltage. In addition, the high-frequency (HF) inductor 2 may be used for purposes such as securing a required frequency by matching impedance, or blocking noise and AC components. In addition, the general bead 3 may be used for the purpose of removing noise of power and signal lines, or removing a high-frequency ripple. In addition, the high-frequency bead (GHz Bead) 4 may be used for the purpose of removing high-frequency noise from signal and power lines related to audio. In addition, the common mode filter 5 may be used for the purpose of passing through a current in a differential mode, and removing only common mode noise.

The electronic device may typically be a smartphone, but an embodiment thereof is not limited thereto, and may be, for example, a personal digital assistant (PDA), a digital video camera, a digital still camera, a network system, a computer, a monitor, a television, a video game, and a smartwatch. In addition to these devices, the electronic device may be other various electronic devices well known to those skilled in the art.

### Coil Component

Hereinafter, coil component of the present disclosure will be described, and for convenience, a structure of a power inductor will be described as an example, but as described above, the coil component of the present disclosure may also be applied to coil components for various other uses.

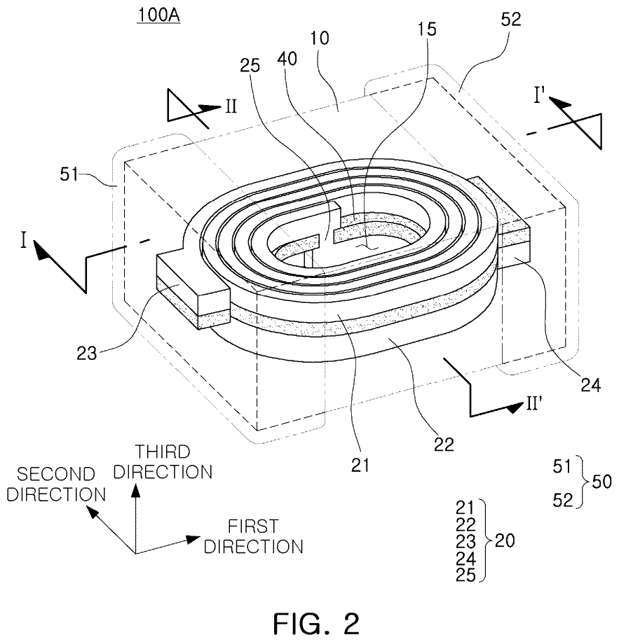

FIG. 2 is a schematic perspective view illustrating an example of a coil component.

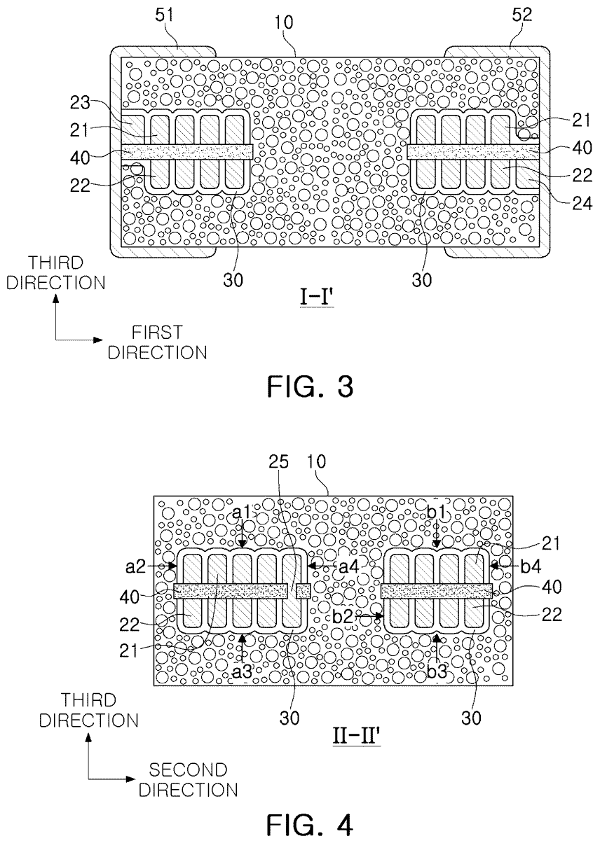

FIG. 3 schematically illustrates an example of a cross-section I-I′ of the coil component of FIG. 2.

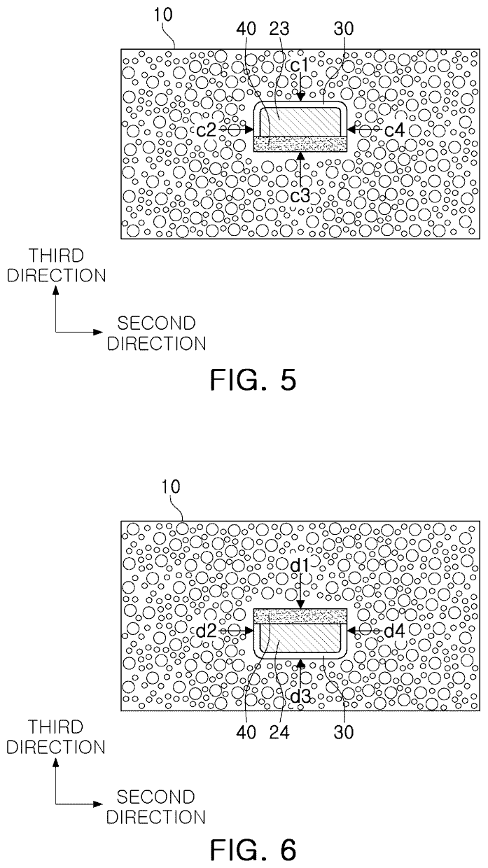

FIG. 4 schematically illustrates an example of a cross-section II-II′ of the coil component of FIG. 2.

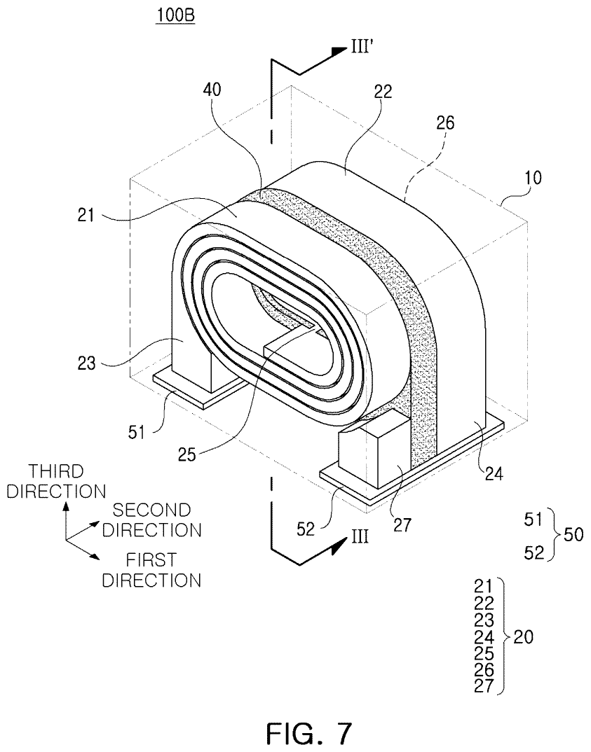

FIG. 5 schematically illustrates an example of one side of the body to which the first lead-out portion of the first coil of the coil component of FIG. 2 is exposed.

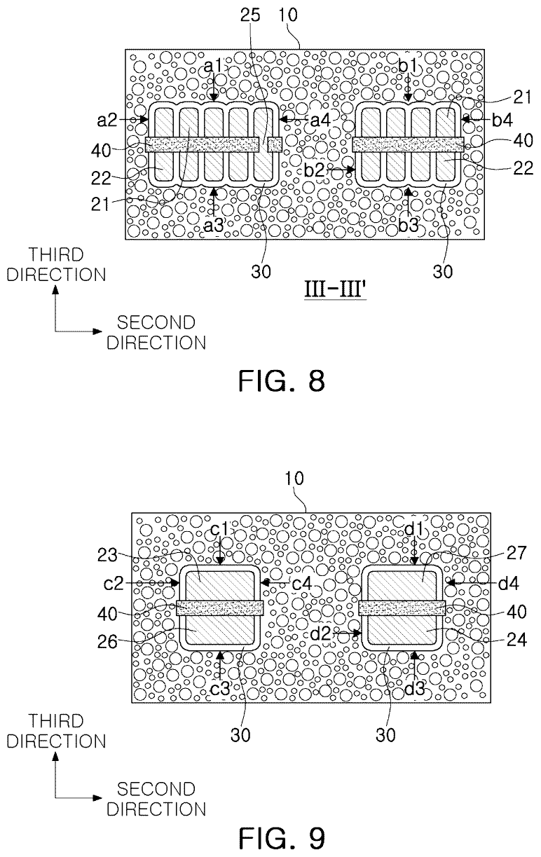

FIG. 6 schematically illustrates an example of the other side surface of the body to which the second lead-out portion of the second coil of the coil component of FIG. 2 is exposed.

Referring to the drawings, a coil component 100A according to an example includes a body 10, a coil 20 disposed in the body 10, and an insulating film 30 covering at least a portion of the coil 20 in the body 10. If necessary, the body 10 may further include a substrate 40 disposed in the body 10 and an electrode 50 disposed on the body 10, and the coil 20 may be disposed on the substrate 40 and electrically connected to the electrode 50.

The insulating film 30 may include a copolymer of a monomer containing an unsaturated bond and a parylene monomer. The copolymer may include a repeating unit derived from a monomer containing an unsaturated bond and a repeating unit derived from a parylene monomer. The monomer containing an unsaturated bond and the parylene monomer may be connected by a cross-linking bond. Since the insulating film 30 includes an organic material, a short-circuit between patterns of the coil 20 and a short-circuit between the coil 20 and a magnetic material of the body 10 may be prevented. In addition, since the insulating film 30 includes a copolymer having such a repeating unit, the insulating film 30 may have superior adhesion and thermal stability properties, as compared to a case in which the insulating film 30 is simply formed by coating parylene only.

In some embodiments, the insulating film 30 may include a copolymer of a monomer containing an unsaturated bond and at least two ether groups and a parylene monomer. In some embodiments, the monomer containing the unsaturated bond and the at least two ether groups may include at least one of an acrylate group and a methacrylate group. In some embodiments, the monomer containing the unsaturated bond and the at least two ether groups may include ethylene glycol dimethacrylate. In some embodiments, the monomer containing the unsaturated bond and the at least two ether groups may include ethylene glycol diacrylate. In some embodiments, the parylene monomer may include parylene N dimer. In some embodiments, the parylene monomer may include para-xylylene. In some embodiments, the monomer containing the unsaturated bond and the at least two ether groups may be aliphatic.

More specifically, in a thin film inductor, or the like, it may be considered to coat a parylene polymer as an insulating film of a coil, but it is difficult to realize sufficient adhesion and thermal stability by simply polymerizing parylene to form a coating layer. Therefore, it may be necessary to synthesize a more rigid material, and from this point of view, in one example, a copolymer of a monomer containing an unsaturated bond and a parylene monomer is used as a material of the insulating film 30. For example, by decomposing a reactive monomer having an unsaturated bond and parylene N dimer to form parylene, and copolymerizing the same in a gas phase in a vapor deposition process, the insulating film 30 may be formed in a form of a thin film coating layer.

Meanwhile, the monomer containing the unsaturated bond may include at least one of a vinyl group, an acrylate group, a methacrylate group, and ethylene. In this case, it may be more effective copolymerized with the parylparylene monomer, as a reactive monomer. For example, the monomer containing an unsaturated bond may include at least one of 2,4,6,8-tetramethyl-2,4,6,8-tetravinylcyclotrasiloxane (V4D4); 1,3,5-trimethyl-1,3,5-trivinylcyclotrisiloxane (V3D3); 1,3-diethenyl-1,1,3,3-tetramethyl-disiloxane (V2D2); 4-vinylpyridine (4VP); divinylbenzene (DVB); diethyleneglycoldivinylether (DEGDVE); ethyleneglycoldiacrylate (EGDA); ethyleneglycoldimethacryl (EGDMA); glycidyl methacrylate (GMA); ethylene; styrene; and methylmethacrylate (MMA). However, an embodiment of the present disclosure is not limited thereto.

Meanwhile, the unsaturated bond, more preferably, may include at least one of an acrylate group and a methacrylate group. For example the monomer containing an unsaturated bond, more preferably, may include at least one of ethylene glycol diacrylate, ethylene glycol dimethacrylate, glycidyl methacrylate, and methyl methacrylate. However, an embodiment of the present disclosure is not limited thereto

Meanwhile, the parylene monomer may be a monomer having a parylene structure in the copolymer after crosslinking with the monomer including an unsaturated bond. For example, the parylene monomer may be parylene N dimer, para-xylylene, or the like, but an embodiment thereof is not limited thereto. When heat is applied to the parylene N dimer, steam decomposition of the monomer may proceed, and as a result, a pyrolytic monomer capable of crosslinking may be obtained. That is, the parylene monomer in the present disclosure is a concept including a compound providing a parylene structure by copolymerizing with a monomer containing an unsaturated bond, and may also include a form in which two monomers before decomposition are connected, such as parylene N dimer.

Meanwhile, a repeating unit of the copolymer may include a structure in which at least one of the repeating units derived from the parylene monomer is bonded to at least one of both ends of at least one of the repeating units derived from the monomer containing an unsaturated bond. In this case, synthesis of a more robust material may be possible.

For example, the copolymer may include a structure represented by [Formula 1].

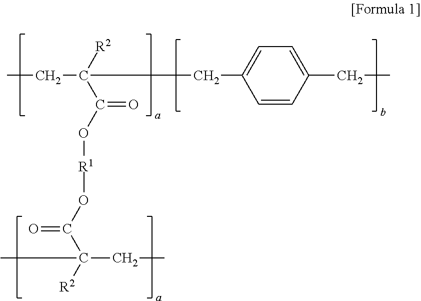

Here, R¹ may be a C₂-C₆ saturated hydrocarbon chain. The saturated hydrocarbon chain may be in a straight-chain or branched form. For example, a C₂-C₆ saturated hydrocarbon chain may be —(CH₂—CH₂)—, —(CH₂—CH₂—CH₂)—, —(CH(—CH₃)—CH₂)—, —(CH₂—CH(—CH₃))—(CH₂—CH₂—CH₂—CH₂)—(CH(—CH₃)—CH₂—CH₂)—(CH₂—CH₂—CH(—CH₃))—(CH₂—CH₂—CH₂—CH₂—CH₂)—(CH₂—CH(—CH₃)—CH₂—CH₂)—(CH₂—CH(—CH₂—CH₃)—CH₂)—(CH₂—CH₂—CH₂—CH₂—CH₂—CH₂)—(CH₂—CH(—CH₃)—CH₂—CH₂—CH₂)—(CH₂—CH(—CH₂—CH₃)—CH₂—CH₂)—, —(CH₂—CH(—CH₂—CH₂—CH₃)—CH₂)—, but an embodiment thereof is not limited thereto. In some embodiments, R¹ may be a C₂ saturated hydrocarbon chain.

In addition, each of R² and R³ may be independently hydrogen or a C₁-C₁₀ alkyl group. The C₁-C₁₀ alkyl group may be, for example, a methyl group, an ethyl group, a propyl group, an isopropyl group, a butyl group, an isobutyl group, a tert-butyl group, a sec-butyl group, a 1-methyl-butyl group, a 1-ethyl-butyl group, a pentyl group, an isopentyl group, a neopentyl group, a tert-pentyl group, a hexyl group, a 1-methylpentyl group, a 2-methylpentyl group, a 4-methyl-2-pentyl group, a 3,3-dimethylbutyl group, a 2-ethylbutyl group, a heptyl group, a 1-methylhexyl group, an octyl group, a nonyl group, a decyl group, and the like, but an embodiment thereof is not limited thereto. In some embodiments, R² may be hydrogen. In some embodiments, R² may be a C₁ alkyl group.

In addition, each of a and b may be independently an integer of 2 to 2500, but an embodiment thereof is not limited thereto. Depending on the number of a and b, the number of repeating units may be controlled, and a molecular weight (Mn) may be controlled.

Meanwhile, in [Formula 1], each repeating unit may be bonded to each other in various combinations thereof. For example, both ends of a repeating unit derived from a monomer containing an unsaturated bond may be bonded to a repeating unit derived from a parylene monomer, or one end thereof may be bonded to a repeating unit derived from a parylene monomer and the other end thereof may be bonded to a repeating unit derived from a monomer containing an unsaturated bond, or both ends thereof may be bonded to a repeating unit derived from a monomer containing an unsaturated bond. Similarly, the other ends of a repeating unit derived from a monomer containing an unsaturated bond may be both bonded to a repeating unit derived from a parylene monomer, one side thereof may be bonded to a repeating unit derived from a parylene monomer and the other side thereof may be bonded to a repeating unit derived from a monomer containing an unsaturated bond, or both sides thereof may be bonded to a repeating unit derived from a monomer containing an unsaturated bond.

As a non-limiting example, the structure represented by [Formula 1] may include a structure represented by [Formula 2] or [Formula 3].

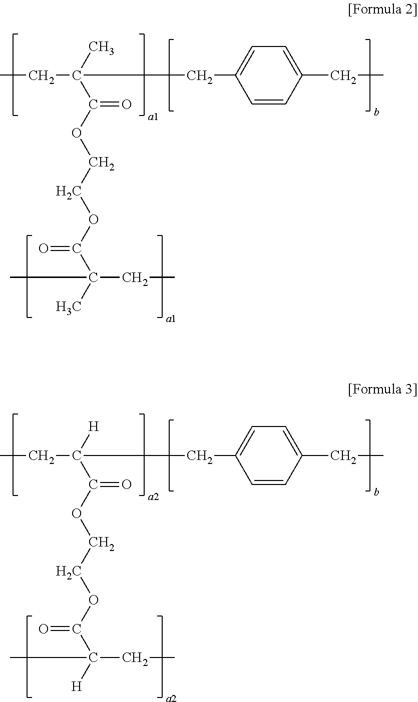

Where, a1, a2, and b may be independently an integer of 2 to 2500, respectively, but an embodiment thereof is not limited thereto. Depending on the number of a1, a2, and b, the number of repeating units may be controlled, and the molecular weight (Mn) may be controlled.

Meanwhile, in [Formula 2] and [Formula 3], each repeating unit may be combined with each other in various combinations as described above.

Meanwhile, the insulating film 30 may be a single layer having a thickness of 1 μm to 10 μm. That is, the insulating film 30 may be in the form of a thin film coating layer. The thickness of the insulating film 30 may be obtained. by grinding the coil component 100A to a depth of about ½ in the first direction or the second direction to obtain a cross-section as shown in FIG. 3 or 4, and then, the thickness of the insulating film 30 measured using an optical microscope, for example, an optical microscope (x1000) manufactured by Olympus. In this case, the thickness of the insulating film 30 may be an average value of thickness numerals measured at three arbitrary points in each of an upper region, a middle region, and a lower region based on a cross-section obtained by grinding.

Meanwhile, a material of the insulating film 30 may be measured through FT-IR, ¹H-NMR, and ¹³C-NMR analysis. For example, as illustrated in FIG. 4, after the coil component 100A is ground to a depth of about ½ in the second direction to obtain a cross-section, the above-described analysis may be performed with respect to the insulating film 30 at points a1 to a4 on a left side of the coil 20 and points b1 to b4 on a right side of the coil 20, respectively. In addition, as illustrated in FIGS. 5 and 6, after exposing both sides of the body 10 to which lead-out portions 23 and 24 of the coil 20 of the coil component 100A are exposed, the above-described analysis may be performed on the insulating film 30 at points c1 to c4 around the first lead-out portion 23 and points d1 to d4 around the second lead-out portion 24, respectively. That is, the material thereof can be measured by analyzing FT-IR, ¹H-NMR, and ¹³C-NMR of the insulating film 30 at a total of 16 points.

Hereinafter, the components of the coil component 100A according to an example will be described in more detail with reference to the drawings.

The body 10 forms an exterior of the coil component 100A. The body 10 may have a hexahedral shape including first and second surfaces opposing each other in a first direction (or a longitudinal direction), third and fourth surfaces opposing each other in a second direction (or a width direction), and fifth and sixth surfaces opposing each other in a third direction (or u thickness direction), but an embodiment thereof is not limited thereto. The first to fourth surfaces may be side surfaces of the body 10, respectively, and the fifth and sixth surfaces may be upper and lower surfaces of the body 10, respectively. Each edge of the body 10 may be ground to have a round shape, but an embodiment thereof is not limited thereto.

For example, the body 10 may be formed such that the coil component 100A has a length of 2.5 mm, a width of 2.0 mm, and a thickness of 1.0 mm, has a length of 2.0 mm, a width of 1.2 mm, and a thickness of 0.65 mm, has a length of 1.6 mm, a width of 0.8 mm, and a thickness of 0.8 mm, has a length of 1.0 mm, a width of 0.5 mm, and a thickness of 0.8 mm, or has a length of 0.8 mm, a width of 0.4 mm, and a thickness of 0.65 mm, but an embodiment thereof is not limited thereto. Meanwhile, since the above-described exemplary dimensions for the length, width, and thickness of the coil component 100A refer to dimensions that do not reflect process errors, it should be considered that they are within the scope of the present disclosure to the extent that process errors may be recognized.

The length of the coil component 100A may refer to a maximum value, among dimensions of a plurality of line segments, connecting two outermost boundary lines of the coil component 100A opposing in a length (L) direction, illustrated in the cross-sectional image, and parallel to a length (L) direction of the coil component 100A, with reference to an image for a cross-section of the coil component 100A in a length (L) direction (L)-a thickness (T) direction in a central portion of the coil component 100A in a width direction (W), obtained by an optical microscope or a scanning electron microscope (SEM). Alternatively, the length of the coil component 100A described above may refer to an arithmetic mean value of at least three dimensions, among a plurality of line segments connecting two outermost boundary lines of the coil component 100A opposing in the length (L) direction illustrated in the cross-sectional image, and parallel to the length (L) direction of the coil component 100A.

The thickness of the coil component 100A described above may refer to a maximum value, among dimensions of a plurality of line segments, connecting an outermost boundary line of the coil component 100A illustrated in the cross-sectional image, and parallel to a thickness(T) direction of the coil component 100A, with reference to an image for a cross-section of the coil component 100A in a length (L) direction-a thickness (T) direction in a central portion of the coil component 100A in a width direction (W), obtained by an optical microscope or a scanning electron microscope (SEM). Alternatively, the thickness of the coil component 100A described above may refer to an arithmetic mean value of at least three dimensions, among a plurality of line segments connecting an outermost boundary line of the coil component 100A illustrated in the cross-sectional image, and parallel to the thickness (T) direction of the coil component 100A. Here, the plurality of line segments parallel to the thickness direction T may be equally spaced from each other in the length direction L, but the scope of the present disclosure is not limited thereto.

The width of the coil component 100A described above may refer to a maximum value, among dimensions of a plurality of line segments, connecting an outermost boundary line of the coil component 100A illustrated in the cross-sectional image, and parallel to the width (W) direction of the coil component 100A, with reference to an image for a cross-section of the coil component 100A in a length (L) direction-a thickness (T) direction in a central portion of the coil component 100A in a width (W) direction, obtained by an optical microscope or a scanning electron microscope (SEM). Alternatively, the width of the coil component 100A described above may refer to an arithmetic mean value of at least three dimensions, among a plurality of line segments, connecting an outermost boundary line of the coil component 100A illustrated in the cross-sectional image, and parallel to the width (W) direction of the coil component 100A.

Each of the length, the width, and the thickness of the coil component 100A may be measured by a micrometer measurement method. The micrometer measurement method may measure sizes by setting a zero point using a Gage repeatability and reproducibility (R&R) micrometer, inserting the coil component 100A according to the present embodiment into a space between tips of the micrometer, and turning a measurement lever of the micrometer. Meanwhile, when the length of the coil component 100A is measured by the micrometer measurement method, the length of the coil component 100A may refer to a value measured one time, or may refer to an arithmetic means of values measured multiple times. The same configuration may also be applied to the width and the thickness of the coil component 100A.

However, an embodiment of the present disclosure is not limited thereto, and the body 10 may have a structure other than a structure in which a magnetic material is dispersed in a resin. For example, the body 10 may be formed of a magnetic material such as ferrite, or may be formed of a non-magnetic material. The ferrite powder may include, for example, one or

more materials among a spinel-type ferrite such as an Mg—Zn-based ferrite, an Mn—Zn-based ferrite, an Mn—Mg-based ferrite, a Cu—Zn-based ferrite, an Mg—Mn—Sr-based ferrite, an Ni—Zn-based ferrite, and the like, a hexagonal-type ferrite such as a Ba—Zn-based ferrite, a Ba—Mg-based ferrite, a Ba—Ni-based ferrite, a Ba—Co-based ferrite, a Ba—Ni—Co-based ferrite, and the like, a garnet-type ferrite such as a Y-based ferrite, and a Li-based ferrite.

The magnetic metal powder may include one or more elements selected from a group consisting of iron (Fe), silicon (Si), chromium (Cr), cobalt (Co), molybdenum (Mo), aluminum (Al), niobium (Nb), copper (Cu), and nickel (Ni). For example, the magnetic metal powder may be one or more materials among pure iron powder, Fe—Si alloy powder, Fe—Si—Al-based alloy powder, Fe—Ni-based alloy powder, Fe—Ni—Mo-based alloy powder, Fe—Ni—Mo—Cu-based alloy powder, Fe—Co-based alloy powder, Fe—Ni—Co-based alloy powder, Fe—Cr-based alloy powder, Fe—Cr—Si-based alloy powder, Fe—Si—Cu—Nb-based alloy powder, Fe—Ni—Cr-based alloy powder, and Fe—Cr—Al-based alloy powder. The magnetic metal powder may be amorphous or crystalline. For example, the magnetic metal powder may be Fe—Si—B—Cr-based amorphous alloy powder, but is not limited thereto.

The resin may include an epoxy, polyimide, a liquid crystal polymer, or the like, along or in combination thereof, but an embodiment thereof is not limited thereto.

The body 10 may include two or more types of magnetic materials dispersed in a resin. Here, the different types of magnetic materials means that the magnetic materials dispersed in the resin are distinguished from each other by any one of an average diameter, composition, crystallinity, and shape. Each of the ferrite and the magnetic metal powder may have an average diameter of about 0.1 μm to 30 μm, but an embodiment thereof is not limited thereto.

The body 10 may have a core 15 penetrating through a coil 20 and a substrate 40, which will be described later. The core 15 may be formed by filling a through hole of the substrate 40 with a magnetic composite sheet, but an embodiment thereof is not limited thereto.

The coil 20 serves to perform various functions in the electronic device Through characteristics expressed from a coil of the coil component 100A. For example, the coil component 100A may be a power inductor, and in this case, the coil 20 may store electricity in a form of a magnetic field to maintain an output voltage to serve to stabilize power.

The coil 20 may include first and second coil patterns 21 and 22 respectively disposed on upper and lower surfaces of the substrate 40, a via 25 penetrating through the substrate 40 to electrically connect the first and second coil patterns 21 and 22, and first and second lead-out portions 23 and 24 extending from an outermost turn of each of the first and second coil patterns 21 and 22.

The first and second patterns 21 and 22 may respectively have a planar spiral shape. The coil pattern of the planar spiral shape may have a minimum number of turns of 2 or more, which is advantageous for implementing thinness and high inductance. The first and second coil patterns 21 and 22 and the first and second lead-out portions 23 and 24 may be a plating pattern formed by an isotropic plating method, but an embodiment thereof is not limited thereto, and may be a plating pattern formed by an anisotropic plating method. Alternatively, the plating pattern may be formed by applying both isotropic plating and anisotropic plating.

The first and second coil patterns 21 and 22 and the first and second lead-out portions 23 and 24 may include a seed layer and a plating layer. The seed layer may include a first metal layer including at least one of titanium (Ti), titanium-tungsten (Ti—W), molybdenum (Mo), chromium (Cr), nickel (Ni,, and nickel (Ni)-chromium (Cr), and a second metal layer including the same material as the plating layer, such as copper (Cu), but an embodiment thereof is not limited thereto. The plating layer may include copper (Cu), aluminum (Al)silver (Ag), tin (Sn), gold (Au), nickel (Ni), lead (Pd), or an alloy thereof, for example, copper (Cu), but an embodiment thereof is not limited thereto.

The via 25 may pass through a substrate 40, and thus may have a thickness corresponding to the substrate 40. The via 25 may electrically connect the first and second coil patterns 21 and 22. A current path may be connected to the first and second coil patterns 21 and 22 through the via 25, and as a result, one coil 20 rotating in the same direction may be formed.

The via 25 may also include a seed layer and a plating layer, and specific examples thereof are as described above, chat is, the via 25 may be formed simultaneously with at least one of the first and second coil patterns 21 and 22, A horizontal cross-sectional shape of the via 25 may be, for example, a circular shape, an elliptical shape, a polygonal shape, or the like. A vertical cross-sectional shape of the via 25 may be, for example, a tapered shape, a reverse tapered s-ape, an hourglass shape, a column shape, or the like.

The insulating film 30 may prevent a magnetic material of the body 10 from contacting the coil 20. The insulating film 30 may cover at least a portion of an outer surface and a top surface of each of the first and second coil patterns 21 and 22 and the first and second lead-out portions 23 and 24. In addition, the insulating film 30 may fill at least a portion of a gap between patterns of each of the first and second coil patterns 21 and 22. In addition, at least a portion of a gap between each of the first and second coil patterns 21 and 22 and each of the first and second lead-out portions 23 and 24 may be filled. As illustrated in FIGS. 5 and 6, at least a portion of the insulating film 30 may be exposed together with the first and second lead-out portions 23 and 24, respectively, on the first and second surfaces of the body 10, both side surfaces opposing each other in the first direction.

The insulating film 30 may cover at least a portion of one surface (front surface) and the other surface (rear surface) of the substrate 40, and may cover a wall surface of the through hole for forming the core 15 of the substrate 40, if necessary. As a result, the insulating film 30 formed on one surface (front surface) and the other surface (rear surface) of the substrate 40 may be connected to each other. However, the present disclosure is not limited thereto, and the insulating film 30 may not be formed on the wall surface of the through hole, and thus the insulating film 30 formed on one surface (front) and the other (rear surface) of the substrate 40 may be cut off from each other.

The substrate 40 is for forming the coil 20 thinner and more easily, and a material or type thereof is not particularly limited as long as it can support the first and second coil patterns 21 and 22 and the first and second lead-out portions 23 and 24. For example, the substrate 40 may be a copper clad laminate (CCL), a polypropylene glycol (PPG) substrate, a ferrite substrate, a metal-based soft magnetic substrate, an insulating substrate formed of an insulating resin, and the like. As the insulating resin, a thermosetting resin such as an epoxy resin, a thermoplastic resin such as polyimide, or a resin impregnated with a reinforcing material such as glass fiber or an inorganic filler therein, for example, prepreg, Ajiriomoto build-up film (ABF), FR-4, Bismaleimide Triazine (BT) resin, Photo Imagable Dielectric (PID) resin, or the like may be used. In view of maintaining rigidity, an insulating substrate including glass fibers and an epoxy resin may be used, but an embodiment of the present disclosure is not limited thereto.

When the coil component 100A is mounted on an electronic device, the electrode 50 may serve to electrically connect the coil component 100A to the electronic device. The electrode 50 may include a first external electrode 51 and a second external electrode 52 disposed on the body 10 to be spaced apart from each other. The first and second external electrodes 51 and 52 may be respectively disposed on the first and second surfaces, both side surfaces, opposing each other in a first direction, and may be respectively connected to first and second lead-out portions. The first and second external electrodes 51 and 52 may partially extend onto the remaining third to sixth surfaces of the body 10, respectively. If necessary, a pre-plating layer (not illustrated) may be disposed on the first and second surfaces of the body 10 in order to improve electrical reliability between the coil 20 and the electrode 50.

The first and second external electrodes 51 and 52 may include, for example, a conductive resin layer and a conductive layer formed on the conductive resin layer. The conductive resin layer may be formed by paste printing, or the like, and may include at least one conductive metal selected from a group consisting of copper (Cu), nickel (Ni) and silver (Ag) and a thermosetting resin such as an epoxy resin. The conductor layer may include at least one selected from a group consisting of nickel (Ni), copper (Cu), and tin (Sn), for example, a nickel (Ni) layer and a tin (Sn) layer may be sequentially formed by plating, but an embodiment thereof is not limited thereto.

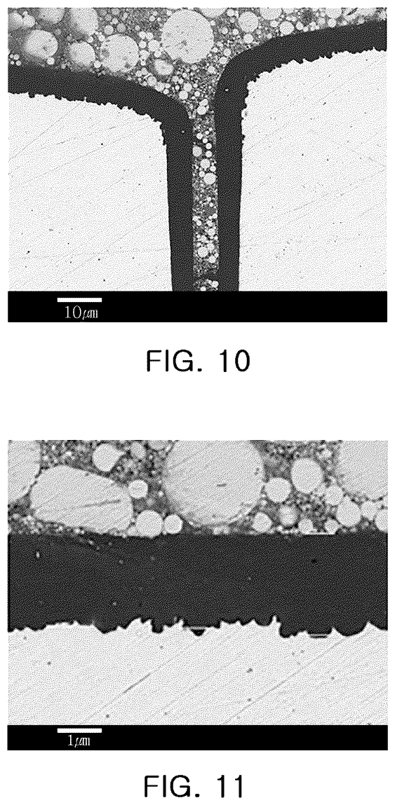

FIG. 7 is a schematic perspective view illustrating another example of a coil component.

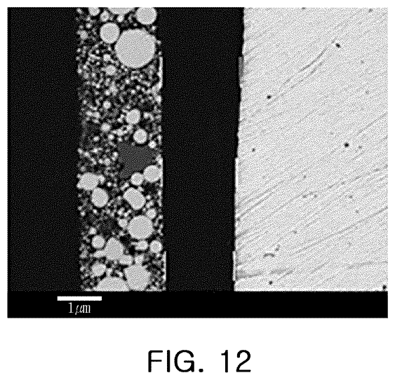

FIG. 8 schematically illustrates an example of a cross-section III-III′ of the coil component of FIG. 7.

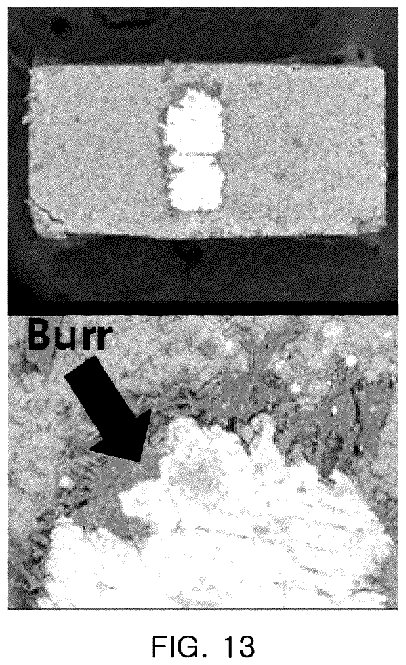

FIG. 9 schematically illustrates an example of a lower surface of a body to which the first and second lead-out portions of the coil component of FIG. 7 are exposed.

Referring to the drawings, in a coil component 100B according to another example, a coil 20 disposed substantially perpendicular to a sixth surface, for example, a lower surface of the body 10, and an electrode 50 is disposed on the sixth surface of the body 10, for example, a lower surface thereof. Hereinafter, content overlapping with the contents described in the coil component 100A according to the above-described example will be omitted, and differences in the coil component 100B according to another example will be mainly described. For example, a material of the insulating film 30, and the like, is the same as described above, and a detailed description thereof will be omitted.

The body 10 may be, for example, formed so that the coil component 100B has a length of 0.8 mm, a width of 0.4 mm and a thickness of 0.8 mm, has a length of 0.8 mm, a width of 0.4 mm and a thickness of 0.65 mm, has a length of 1.0 mm, a width of 0.7 mm and a thickness of 0.8 mm, or a length of 1.0 mm, a width of 0.6 mm and a thickness of 0.8 mm, or a length of 1.0 mm, a width of 0.5 mm and a thickness of 0.8 mm, or a length of 1.0 mm, a width of 0.5 mm and a thickness of 0.65 mm, or a length of 1.0 mm, a width of 0.5 mm and a thickness of 0.6 mm, but an embodiment thereof is not limited thereto. Meanwhile, since the above-described. exemplary numerical values for the length, width, and thickness of the coil component 100B refer to numerical values that do not reflect process errors, numerical values in a range that can be recognized as process errors should be considered to correspond to the above-described exemplary numerical values.

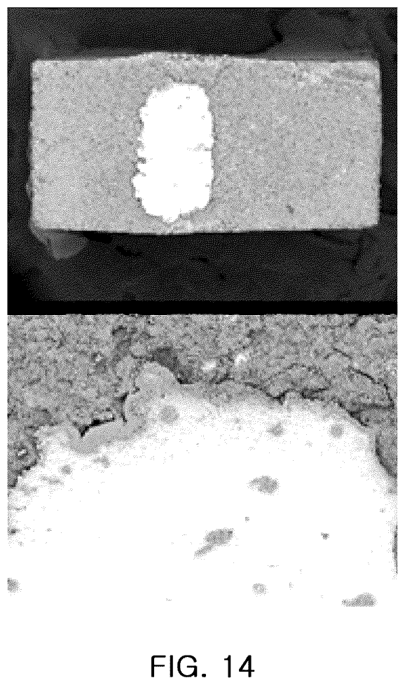

The coil 20 and the substrate 40 may be disposed substantially perpendicular to the sixth surface of the body 10, for example, a lower surface of the body 10, respectively. Accordingly, as illustrated. in FIG. 10, both first and second lead-out portions 23 and 24 of the coil 20 may be exposed to the sixth surface, for example, the lower surface of the body 10. In addition, at least a portion of the insulating film 30 may be exposed to the sixth surface, for example, the lower surface of the body 10, together with the first and second lead-out portions 23 and 24.

The coil 20 may further include a first sub lead-out portion 26 and a second sub lead-out portion 27 as necessary. For example, the coil 20 may be disposed on the other surface (rear surface) of the substrate 40 to be spaced apart from a second coil pattern 22, and covered by the insulating film 30, and the first sub lead-out portion 26 connected to a first external electrode 51 may be disposed thereon. In addition, the coil 20 may be disposed on one surface (front surface) of the substrate 40 to be spaced apart from a first coil pattern 21, and covered by the insulating film 30, and further include a second lead-out portion 27 connected to a second external electrode 52. In this case, a contact area between the coil 20 and the electrode 50 is increased, so that coupling force therebetween may be further improved. In addition, it may be more effective for warpage control due to a symmetry effect.

The coil 20 may further include first and second sub-vias, if necessary. For example, the first sub-via may pass through the substrate 40 to electrically connect the first lead-out portion 23 and the first sub lead-out portion to each other. In addition, the second sub-via may pass through the substrate 40 to electrical connect the second lead-out portion 24 and the second sub lead-out portion 27 to each other. In this case, when a contact area between the coil 20 and the electrode 50 is increased, the DC resistance Rdc may be further reduced.

The first and second external electrodes 51 and 52 may be disposed on the sixth surface of the body 10, for example the lower surface thereof, to be spaced apart from each other. For example, the coil component 1003 according to another example may have a bottom electrode structure. The first external electrode 51 may be connected to the first lead-out portion 23 and the first sub lead-out portion 26. The second external electrode 52 may be connected to the second lead-out portion 24 and the second sub lead-out portion 27.

### EXPERIMENTAL EXAMPLE

### Example

A plurality of samples having the structure of the

coil component 1003 according to another example described above were manufactured. Specifically, a coil was formed by copper plating on a panel-sized substrate, and the coil was loaded into a CVD chamber to perform copolymer vapor deposition coating to form an insulating film. Thereafter, magnetic sheets, and the like, were laminated and cut into respective chip sizes to prepare a plurality of samples. As a material for forming the insulating film, ethylene glycol dimethacrylate (EGDMA) was used as a monomer having an unsaturated bond, and parylene N dimer was used as a parylene monomer. These monomers were copolymerized in a gas phase using a vapor deposition process to form an insulating film in a form of a thin-film coating layer. Physical properties of the material for forming the insulating film are as illustrated in [Table 1] below, and physical properties of parylene N dimer were replaced with those of para-xylylene.

TABLE 1

| Material name | | | Para-Xylylene | EGDMA |
|---|---|---|---|---|
| Molecular formula | | | C₈H₁₀ | C₁₀H₁₄O₄ |
| Molecular weight | | | 106.16 | 198.22 |
| Density | | | 1.05 | 1.053 |
| Modulus (GPa) | | | 2.4 | 2 |
| Elongation (%) | | | 250 | 5.50 |
| Breakdown voltage (V/μm) | | | 280 | 400 |
| CTE (ppm/° C.) | 25-70° | C. | 46.5 | 13.4 |
| | 70-140° | C. | 41.6 | 19.3 |
| | 140-260° | C. | 16.6 | 19.0 |

### Comparative Example

In the above-described embodiment, a sample of the coil component was manufactured in the same mariner except that an insulating film was formed in a form of a thin film insulating layer using only parylene. Specifically, the parylene monomer was polymerized in a gas phase using a vapor deposition process to form an insulating film in a form of a thin film coating layer. Meanwhile, for various experiments, a plurality of samples of Comparative Examples were also prepared.

FIGS. 10 to 12 schematically illustrate various examples of cross-sections for measuring a thickness of an insulating film of the coil component according to an embodiment.

Specifically, after obtaining a cross-section by grinding any one of samples in Example in a width direction to a depth of about ½, a thickness of an insulating film was measured using an optical microscope (x1000) manufactured by Olympus. FIG. 10 is an image illustrating a top surface and a side surface of a coil pattern, and FIGS. 11 and 12 are images illustrating a top surface and a side surface of the coil pattern in an enlarged manner, respectively. As illustrated in the figure, it can be seen that the insulating film is a single layer in a form of a thin film coating layer having a thickness of about 5 μm.

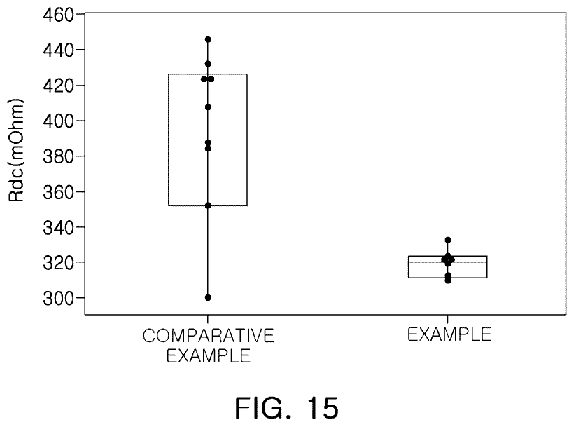

FIGS. 13 and 14 schematically illustrate a cross-section for checking whether an insulating film on the lead-out portion of the coil component according to Example and Comparative Example, is damaged, respectively.

Specifically, after obtaining a cross-section by grinding any one of the samples of each of Examples and Comparative Examples to expose the lead-out portion, respectively, it was checked whether each insulating film was damaged using an optical microscope (x1000) manufactured by Olympus. As illustrated in FIG. 13, the sample of Example has no damage to the insulating film, but as illustrated in

FIG. 14, it can be seen that the sample of Comparative Example has burring on the insulating film.

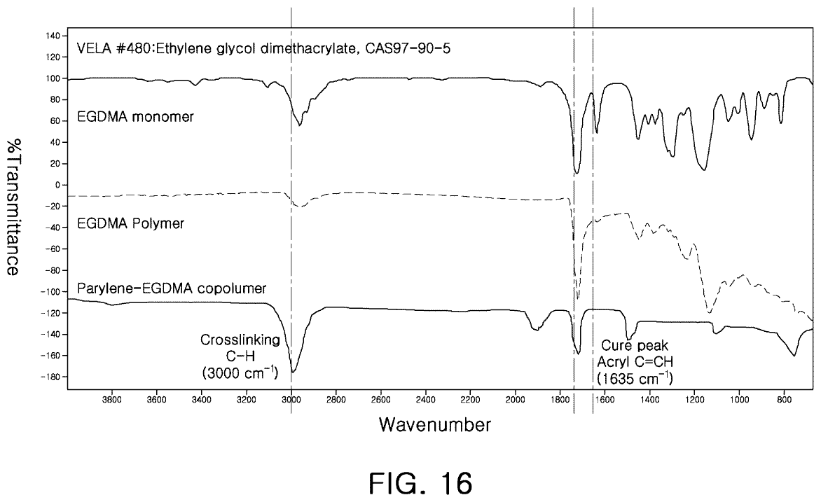

FIG. 15 schematically illustrates a direct current resistance (Rdc) and dispersion of coil components according to Examples and Comparative Examples.

Specifically, direct current resistance (Rdc) and dispersion of any one of samples of each of Examples and Comparative Examples were measured using Rdc Multimeter and Probe, respectively. As illustrated in the figures, it can be seen that the DC resistance (Rdc) of the sample of Example is reduced and the dispersion is lower than that of the sample of the Comparative Example.

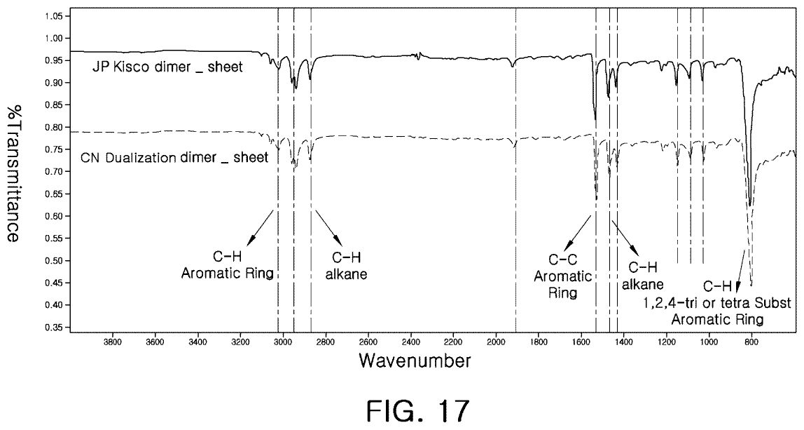

FIGS. 16 and 17 schematically illustrate results of analyzing a material of the insulating film of the coil component according to Examples and Comparative Examples by an FT-IR spectrum, respectively.

Specifically, any one of samples of each of Examples and Comparative Examples was ground to expose first and second lead-out portions, respectively and in a cross-section obtained by grinding, FT-IR analysis was performed at 4 points around the first lead-out portion and 4 points around the second lead-out portion, respectively. In addition, any other one of the samples of each of Examples and Comparative Examples was ground to a depth of about ½ in a width direction, respectively, and in a cross-section obtained by grinding, FT-IR analysis was performed at 4 left points and 4 right points of the coil, respectively. A spectrum at 16 points in each of Examples and Comparative Examples was slightly different, but as the materials were the same as each other, a representative peak value was the same, Results at any one point the spectrum at 16 points in each of Examples and Comparative Examples were illustrated FIGS. 16 and 17. As illustrated in the figure, in the case of the example sample, various peaks of a Parylene-EGDMA copolymer may be identified through an FT-IR spectrum. addition, in the case of the sample of Comparative Example, various peaks of the Parylene polymer may be identified through the FT-IR spectrum.

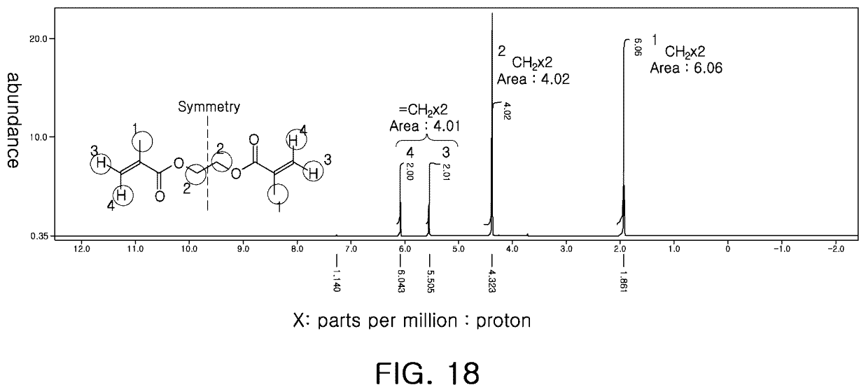

FIG. 18 schematically illustrates a result of analyzing a material of an insulating film of the coil component according to Example by an ¹H-NMR spectrum.

Specifically, any one of samples of Examples was ground to expose first and second lead-out portions, and in a cross-section obtained by grinding, ¹H-NMR analysis was performed at 4 points around the first lead-out portion and 4 points around the second lead-out portion, respectively, specifically, ¹H-NMR analysis was performed. In addition, any other one of the samples of each of Examples was ground to a depth of about ½ in a width direction, respectively, and in a cross-section obtained by grinding, ¹H-NMR analysis was performed at 4 left points and 4 right points of the coil, respectively, specifically, ¹H-NMR analysis was performed, Spectra at 16 points in Examples were slightly different, but as the materials were the same as each other, a representative peak value was the same. A result at any one point in the spectrum at 16 points in Examples was illustrated in FIG. 18. As illustrated in the figure, in the case of the sample in Examples, an EGDMA structure may be inferred from a peak shift and an area value of ¹H-NMR,

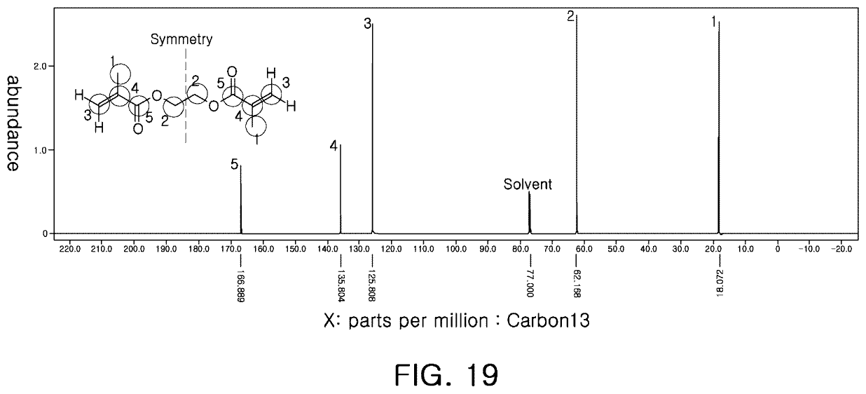

FIG. 19 schematically illustrates a result of analyzing a material of an insulating film of a coil component according to an embodiment by a ¹³C-NMR spectrum,

Specifically, any one of samples of Examples was ground to expose first and second lead-out portions, and in a cross-section obtained by grinding, ¹³C-NMR analysis was performed at 4 points around the first lead-out portion and 4 points around the second lead-out portion, respectively, specifically, ¹³C-NMR analysis was performed. In addition, any other one of the samples of each of Examples was ground to a depth of about ½ in a width direction, respectively, and in a cross-section obtained by grinding, ¹³C-NMR analysis was performed at 4 left points and 4 right points of the coil, respectively, specifically, ¹³C-NMR analysis was performed. As illustrated in the figure, in the case of the sample of Examples, an EGDMA structure may be inferred from a peak shift and an area value of ¹³C-NMR.

Meanwhile, in the present disclosure, the meaning being substantially vertical includes not only a case in which perfect verticality is present, but also a case in which it is approximate verticality is present, in consideration of process errors.

In addition, in the present disclosure, the meaning of being electrically connected is a concept including both a case in which it is physically connected and a case in which it is not connected.

As set forth above, as one effect among various effects of the present disclosure, a coil component having an improved coil withstand voltage may be provided through an insulating film, an organic thin film layer.

As another effect among various effects of the present disclosure, a coil component having improved burring on an external terminal exposed surface may be provided through an insulating film, an organic thin film layer.

As another effect among various effects of the present disclosure, a coil component capable of improving DC resistance characteristics dispersion may be provided through improvement of an external terminal burring.

As another effect among various effects of the present disclosure, a coil component capable of matching a coefficient of thermal expansion between a coil and a magnetic body in the body may be provided through an insulating film, an organic thin film layer.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items. It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

However, various and advantageous advantages and effects of the present disclosure are not limited to the above description, and will be more readily understood in the process of describing specific embodiments of the present disclosure.

While example embodiments have been shown and described above, it will be apparent to those skilled in the art that modifications and variations could be made without departing from the scope of the present disclosure as defined by the appended claims.

What is claimed is:

1. A coil component, comprising:
a body;
a coil disposed within the body; and
an insulating film covering at least a portion of the coil in the body,
wherein the insulating film comprises a copolymer including a repeating unit derived from a monomer containing an unsaturated bond and a repeating unit derived from a parylene monomer.

2. The coil component of claim 1, wherein the monomer containing the unsaturated bond comprises at least one of a vinyl group, an acrylate group, a methacrylate group, and ethylene.

3. The coil component of claim 2, wherein the monomer containing the unsaturated bond comprises at least one of 2,4,6,8-tetramethyl-2,4,6,8-tetravinylcyclotetrasiloxane, 1,3,5-trimethyl-1,3,5-trivinylcyclotrisiloxane, 1,3-diethenyl-1,1,3,3-tetramethyl-disiloxane, 4-vinylpyridine, divinylbenzene, diethylene glycol divinyl ether, ethylene glycol diacrylate, ethylene glycol dimethacrylate, glycidyl methacrylate, ethylene, styrene, and methyl methacrylate.

4. The coil component of claim 1, wherein the monomer containing the unsaturated bond comprises at least one of an acrylate group and a methacrylate group.

5. The coil component of claim 4, wherein the monomer containing the unsaturated bond comprises at least one of ethylene glycol diacrylate, ethylene glycol dimethacrylate, glycidyl methacrylate, and methyl methacrylate.

6. The coil component of claim 5, wherein the copolymer comprises a structure in which at least one of repeating units derived from the parylene monomer is bonded to at least one of each of both ends of at least one of repeating units derived from the monomer containing the unsaturated bond, respectively.

7. The coil component of claim 1, wherein the parylene monomer comprises at least one of parylene N dimer and para-xylylene.

8. The coil component of claim 1, wherein the insulating film is a single layer having a thickness of 1 μm to 10 μm.

9. The coil component of claim 1, wherein the body comprises a magnetic material.

10. The coil component of claim 1, further comprising:
a substrate disposed within the body,
wherein the coil comprises first and second coil patterns in a planar spiral shape, respectively disposed on one surface and the other surface of the substrate, a via penetrating through the substrate and electrically connecting the first and second coil patterns, and first and second lead-out portions extending from an outermost turn of each of the first and second coil patterns.

11. The coil component of claim 10, wherein the insulating film is configured to cover at least a portion of an outer surface and a top surface of each of the first and second coil patterns and the first and second lead-out portions, fill at least a portion of a gap between patterns of each of the first and second coil patterns, and fill at least a portion of a gap between each of the first and second coil patterns and each of the first and second lead-out portions.

12. The coil component of claim 10, further comprising:
an electrode disposed on the body,
wherein the electrode comprises first and second external electrodes, respectively disposed on one side surface and the other side surface of the body and respectively connected to the first and second lead-out portions.

13. The coil component of claim 10, further comprising:
an electrode disposed on the body,
wherein the electrode comprises first and second external electrodes disposed on a lower surface of the body to be spaced apart from each other and respectively connected to the first and second lead-out portions.

14. A coil component, comprising:
a body;
a coil disposed within the body; and
an insulating film covering at least a portion of the coil in the body,
wherein the insulating film comprises a copolymer including a structure represented by the following [Formula 1], 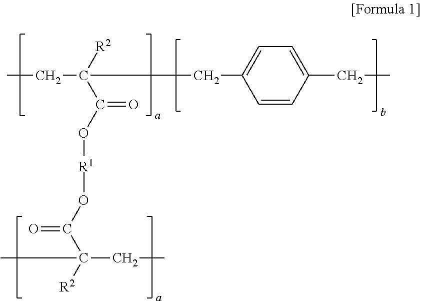
where R¹ is a C₂-C₆ saturated hydrocarbon chain, R² and R³ are each independently hydrogen or a C₁-C₁₀ alkyl group, and a and b are each independently an integer of 2 to 2500.

15. The coil component of claim 14, wherein the structure represented by the [Formula 1] comprises a structure represented by the following [Formula 2] or [Formula 3], 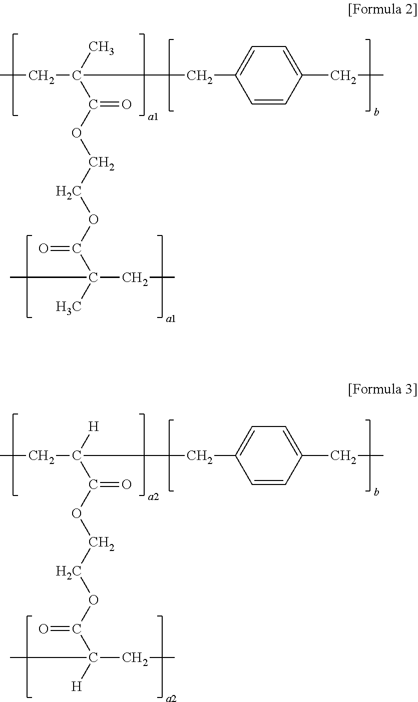
where a1, a2, and b are each independently an integer from 2 to 2500.

16. The coil component of claim 14, wherein the insulating film is in a form of a thin film coating layer.

17. The coil component of claim 14, wherein R¹ is a C₂ saturated hydrocarbon chain.

18. The coil component of claim 14, wherein R² hydrogen.

19. The coil component of claim 14, wherein R² is a C₁ alkyl group.

20. A coil component, comprising:
a body;
a coil disposed within the body; and
an insulating film covering at least a portion of the coil in the body,
wherein the insulating film comprises a copolymer including:
a repeating unit derived from a monomer containing an unsaturated bond and at least two ether groups, and
a repeating unit derived from a parylene monomer.

21. The coil component of claim 20, wherein the monomer containing the unsaturated bond and the at least two ether groups comprises at least one of an acrylate group and a methacrylate group.

22. The coil component of claim 20, wherein the monomer containing the unsaturated bond and the at least two ether groups comprises ethylene glycol dimethacrylate.

23. The coil component of claim 20, wherein the monomer containing the unsaturated bond and the at least two ether groups comprises ethylene glycol diacrylate.

24. The coil component of claim 20, wherein the parylene monomer comprises parylene N dimer.

25. The coil component of claim 20, wherein the parylene monomer comprises para-xylylene.

26. The coil component of claim 20, wherein the monomer containing the unsaturated bond and the at least two ether groups is aliphatic.
